(19) United States
(12) Patent Application Publication
(10) Pub. No.: US 2008/0196573 A1
(43) Pub. Date: Aug. 21, 2008

(54) Fastening structure for transmission rod of drum hammer

(76) Inventor: Chi-Cheng Chang, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/706,453

(22) Filed: Feb. 15, 2007

(51) Int. Cl. G10D 13/02

(52) U.S. Cl. 84/422.1

(57) ABSTRACT

A fastening structure for a transmission rod of a drum hammer is disclosed and comprises: a transmission rod, which is connected to at least two pedals for transmitting power; two universal connectors, which are disposed two ends of the transmission rod respectively, each of the universal connectors has a female-connecting end, a female-connecting hole is disposed in the female-connecting end, an upper portion in the female-connecting hole has a plane, which corresponds to a through hole disposed in a lower portion of the female-connecting hole; two axes, an end of each axis has a plane; and two fixing structures, each fixing structure has a clamping member, which has an inner hole and a screw hole from the top of the clamping member through to the inner hole, a fixing column is disposed in the clamping member other than the screw hole; wherein the clamping member fastens the female-connecting end, a screw inserted in the screw hole is pressed on the periphery of the female-connecting end, the fixing column is inserted from the through hole disposed in the bottom of the female-connecting end and urged on a bottom slot of the end of the axis, the plane is closely contacted with the female-connecting end so as to let the power be indeed transmitted to effectively hit a drum.

### BACKGROUND OF THE INVENTION

1. Field of the Invention

The present invention generally relates to a fastening structure for a transmission rod of a drum hammer, more particularly to a fastening structure as clamping member being capable of effectively fastening a location between the transmission rod of the drum hammer and an axis.

2. Description of the Prior Art

With reference to FIG. 1, which illustrates a schematic view of a first preferred embodiment of a fastening structure for a transmission rod of a drum hammer in prior arts. The fastening structure includes: a transmission rod 10, which is connected to two pedals 20 and 21 for transmitting power as shown in FIG. 6, the transmission rod is a square rod or a round rod; two universal connectors 30 and 30a, which are disposed two ends of the transmission rod 10 respectively, each of the universal connectors 30 and 30a has a female-connecting end 31, a female-connecting hole 311 is disposed in the female-connecting end 31, an upper portion in the female-connecting hole 311 has a plane 312; two axes 40 and 41, two ends 401 and 411 of the axes 40 and 41 have two planes respectively.

With afore description, the axis 41 as shown in FIG. 6 is driven by the pedal 21. Power is transmitted to the axis 40 by means of the universal connector 30a, the transmission rod 10, and the universal connector 30 so as to drive a drum hammer 42.

A combined fastening structure of the female-connecting end 31 and the axis 40 or the axis 41 is described as follows. That is, the axis 40 or the axis 41 corresponds to the female-connecting hole 311, so that the end 401 or the end 411 of the axis 40 or the axis 41 is inserted into the female-connecting hole 311, then a screw 43 goes through a screw hole 313 of the female-connecting end 31, and the screw 43 is fastened on the end 401 or the end 411 of the axis 40 or the axis 41.

With reference to FIG. 2, which illustrates a schematic view of a second preferred embodiment of the fastening structure for the transmission rod of the drum hammer in prior arts. Wherein the axis 40 or the axis 41 corresponds to the female-connecting hole 311, so that the end 401 or the end 411 of the axis 40 or the axis 41 is inserted into the female-connecting hole 311, then two screws 43 vertical each other go through the screw holes 313 of the female-connecting end 31, and the screws 43 are fastened on the end 401 or the end 411 of the axis 40 or the axis 41.

As a conclusion, the two preferred embodiments of prior arts may have the drawbacks listed below:
1. The force to step on the pedals is very powerful, and only one screw may not approach the effect of fastening and be easily loosed so as to cause invalid transmission. It is obvious that the strength of the drum hammer is not enough to impact the drum so as to cause the performance of the drum being down.
2. The screw or screws are easily loosed to cause the derivation of the transmission rod or the axes. Therefore the transmission is definitely affected and may cause some problems.

### SUMMARY OF THE INVENTION

The problems to be solved are repeated as following description. The force to step on the pedals is very powerful, and only one screw may not approach the effect of fastening and be easily loosed so as to cause invalid transmission. It is obvious that the strength of the drum hammer is not enough to impact the drum in an attempt to cause the performance of the drum being down, further to the performance of a performer. And the screw or screws are easily loosed to cause the derivation of the transmission rod or the axes. Therefore the transmission is definitely affected and may cause some problems, such as the drum hammer being not touched onto the drum.

The primary objective of the present invention is to provide a fastening structure for the transmission rod of the drum hammer, comprises: a transmission rod, which is connected to two pedals for transmitting power, the transmission rod is either a round rod or a square rod; two universal connectors, which are disposed two ends of the transmission rod respectively, each of the universal connectors has a female-connecting end, a female-connecting hole is disposed in the female-connecting end, an upper portion in the female-connecting hole has a plane, which corresponds to a through hole disposed in a lower portion of the female-connecting hole; two axes, an end of each axis has a plane; and two fixing structures, each fixing structure having a clamping member, which has an inner hole and a screw hole from the top of the clamping member through to the inner hole, a fixing column being disposed in the clamping member other than the screw hole; wherein the clamping member fastens the female-connecting end, a screw inserted in the screw hole is pressed on the periphery of the female-connecting end, the fixing column is inserted from the through hole disposed in the bottom of the female-connecting end and urged on a bottom slot of the end of the axis, the plane is closely contacted with the female-connecting end. Hence, the universal connector is pressed down further by the screw and the end of the axis is urged upper in order to tightly combined.

The present invention has solved the drawbacks according to the prior arts, and the solutions are described listed below:
1. Due to that the fixing structures with the clamping members respectively cooperating with the fixing columns and the screws, the female-connecting ends are pressed down from the top thereof and the fixing columns are urged up to continuously push the axes, thus the female-connecting ends and the axes are clamped by two forces, which are corresponded each other. Further, the female-connecting ends and the axes may not be loosed again.
2. Due to the female-connecting ends and the axes are firmly fastened, the strength to step on the pedals is indeed transmitted to the drum. So that the performer can completely play the drum for perfect performance.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 illustrates a schematic view of a first preferred embodiment of a fastening structure for a transmission rod of a drum hammer in prior arts;

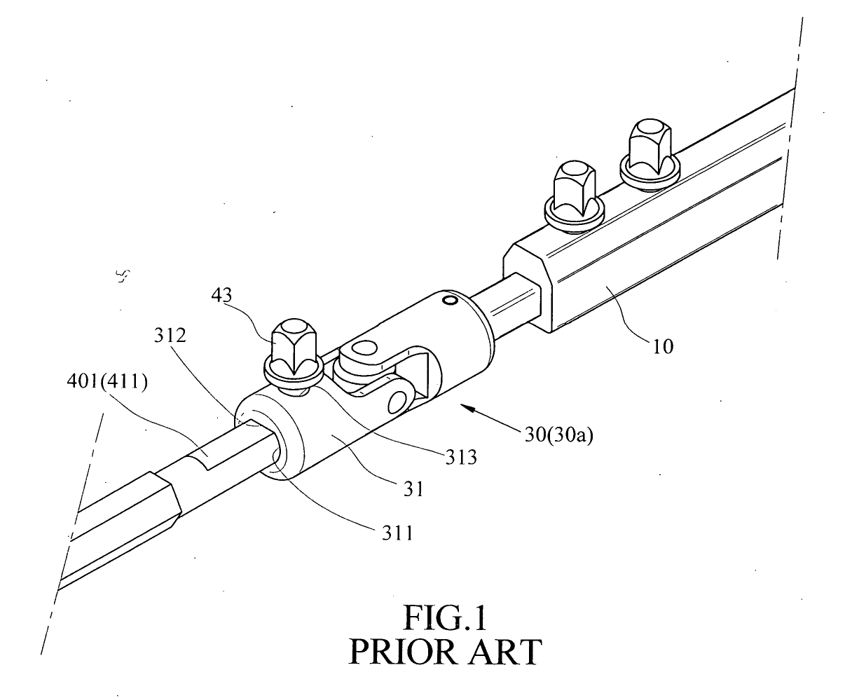

FIG. 2 illustrates a schematic view of a second preferred embodiment of the fastening structure for the transmission rod of the drum hammer in prior arts;

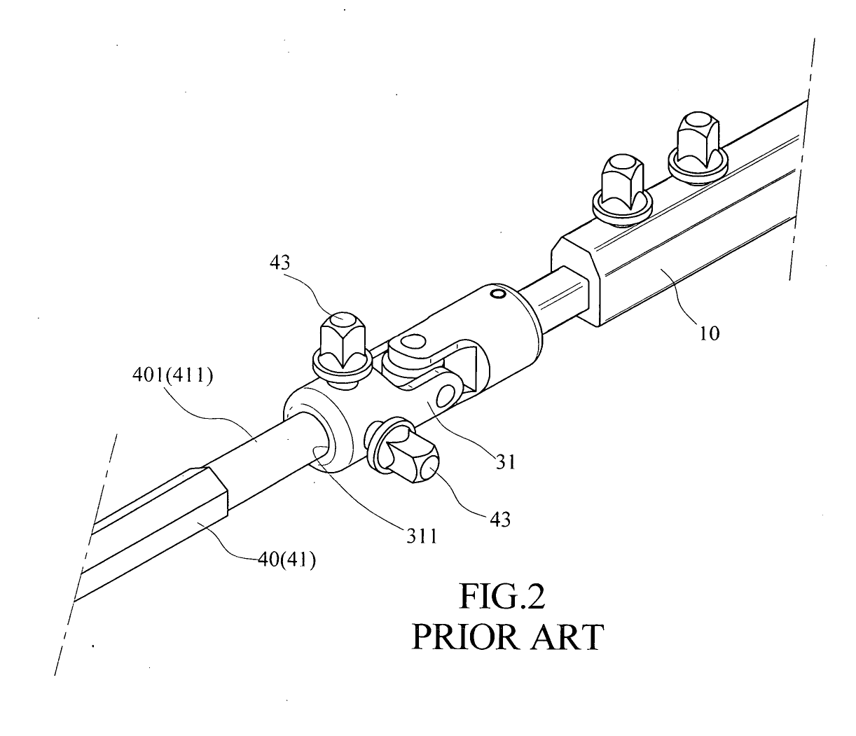

FIG. 3 illustrates a schematic 3-D view of a fastening structure for a transmission rod of a drum hammer of the present invention;

FIG. 4 illustrates a sectional view of a first preferred embodiment of the fastening structure for the transmission rod of the drum hammer of the present invention;

FIG. 5 illustrates a sectional view of a second preferred embodiment of the fastening structure for the transmission rod of the drum hammer of the present invention; and

FIG. 6 illustrates a schematic structural view of two pedestals of the drum hammer of the present invention.

### DETAILED DESCRIPTION OF THE INVENTION

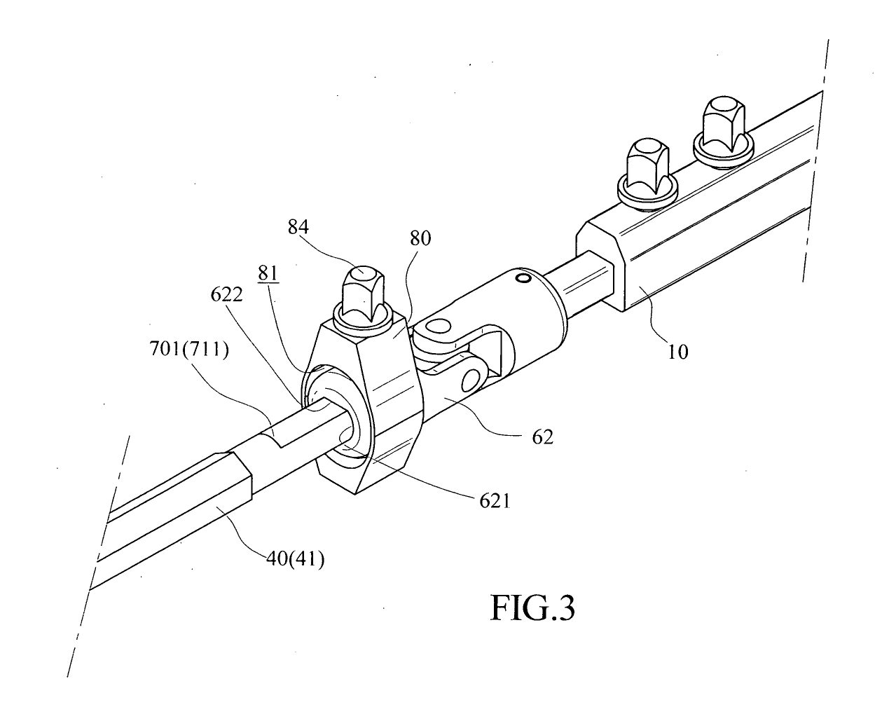

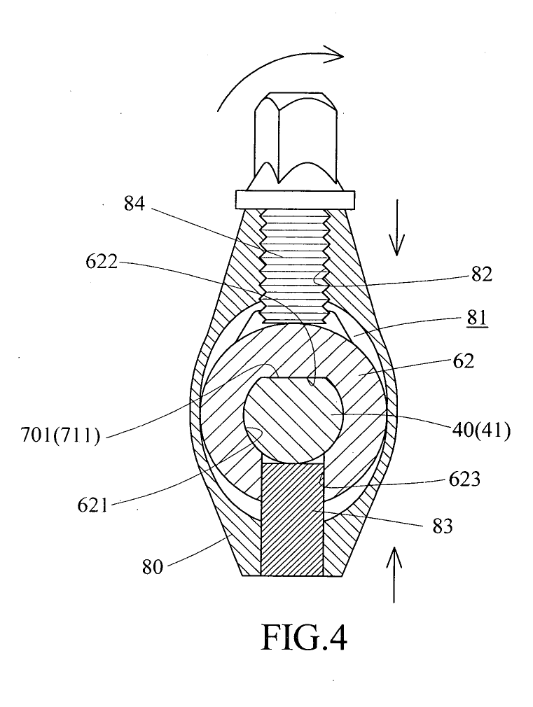

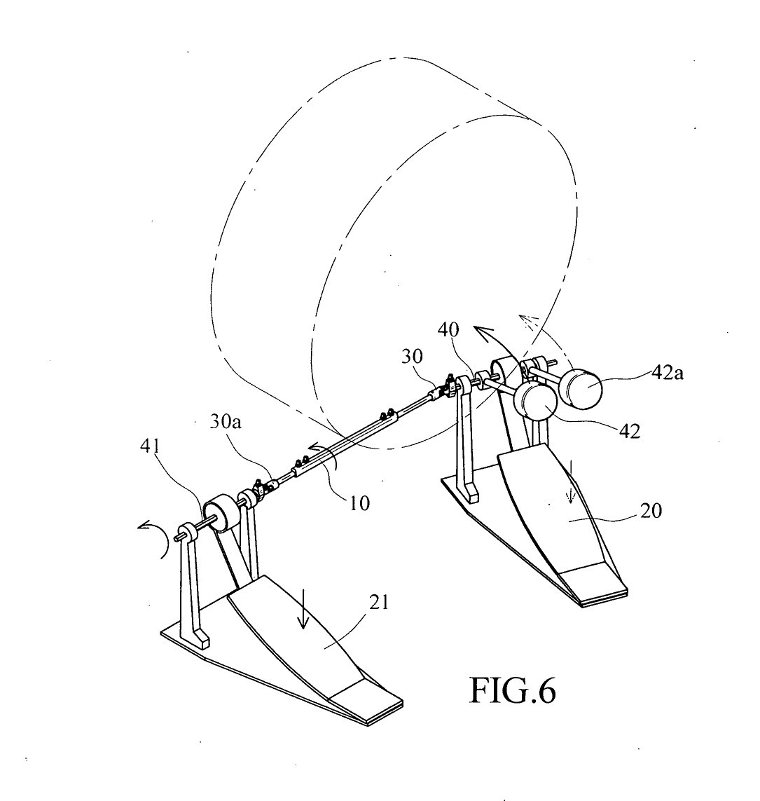

With reference to FIG. 3, FIG. 4, and FIG. 6, which illustrate a schematic 3-D view of a fastening structure for a transmission rod of a drum hammer of the present invention, a sectional view of a first preferred embodiment of the fastening structure for the transmission rod of the drum hammer of the present invention, and a schematic structural view of two pedestals of the drum hammer of the present invention. The fastening structure includes a transmission rod 10, which is connected to two pedals 20 and 21 for transmitting power and can be a round rod or a square rod; two universal connectors 30 and 30a, which are disposed two ends of the transmission rod 10 respectively, each of the universal connectors 30 and 30a has a female-connecting end 62, a female-connecting hole 621 is disposed in the female-connecting end 62, an upper portion in the female-connecting hole 621 has a plane 622, which corresponds to a through hole 623 disposed in a lower portion of the female-connecting hole 621; two axes 40 and 41, two ends of the two axes 40 and 41 have two planes 701 and 711 respectively; and two fixing structures, each fixing structure having a clamping member 80, which has an inner hole 81 and a screw hole 82 from the top of the clamping member 80 through to the inner hole 81, a fixing column 83 is disposed in the clamping member 80 other than the screw hole 82.

With reference to FIG. 4 again, the clamping member 80 fastens the female-connecting end 62, a screw 84 inserted in the screw hole 82 is pressed on the periphery of the female-connecting end 62, the fixing column 83 is inserted from the through hole 623 disposed in the bottom of the female-connecting end 62 and urged on a bottom slot of the end of the axis 40 or the axis 41, the plane 701 or the plane 711 is closely contacted with the plane 622 of the female-connecting end 62. Such that, the screw 84 further presses the female-connecting end 62 down, and therefore the axis 40 or the axis 41 is further urged toward an upper location in order to let the plane 622 and the plane 701 or the plane 711 be tightly combined without loosing.

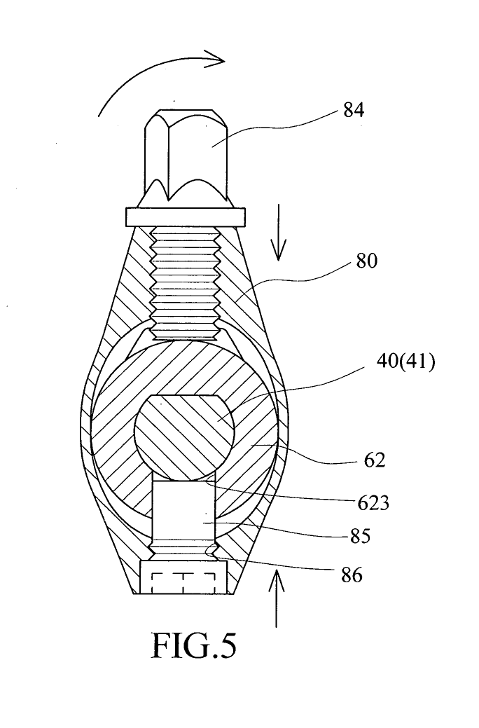

With reference to FIG. 5, which illustrates a sectional view of a second preferred embodiment of the fastening structure for the transmission rod of the drum hammer of the present invention. The fixing column 83 of the clamping member 80 can be replaced by a screw 85. The original position of the fixing column 83 is now a through hole 86 so as to let the screw 85 be through. The screw 85 goes through the through hole 623 of the female-connecting end 62 to urge the bottom slot of the axis 40 or the axis 41. Then the means of the screw 84 through the top of the clamping member 80 pressing on the periphery of the female-connecting end 62 is cooperated to let the axis 40 or the axis 41 and the female-connecting end 62 be tightly combined.

With reference to FIG. 6 again, there are two pedals 20 and 21. The pedal 20 is capable of directly transmitting power from the drum hammer 42a for hitting the drum. The other pedal 21 is not the same as the pedal 20. That is, the power from the pedal 21 is transmitted through the axis 41, the universal connector 30a, the transmission rod 10, the universal connector 30, to the axis 40, hence the drum hammer 42 is driven to hit the drum.

The present invention adopts the means of the screws pressing down on the female-connecting ends and the fixing columns urging the axes up to let the female-connecting ends and the axes be tightly clamped. Such that, the power from the pedals is indeed transmitted to hit the drum in order to fully control the strength of hitting. Thus the performer can completely play the drum to approach the best performance.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A fastening structure for a transmission rod of a drum hammer, comprising:
a transmission rod, which is connected to at least two pedals for transmitting power;
two universal connectors, which are disposed two ends of the transmission rod respectively, each of the universal connectors having a female-connecting end, a female-connecting hole being disposed in the female-connecting end, an upper portion in the female-connecting hole having a plane, which corresponds to a through hole disposed in a lower portion of the female-connecting hole;
two axes, an end of each axis having a plane; and
two fixing structures, each fixing structure having a clamping member, which has an inner hole and a screw hole from the top of the clamping member through to the inner hole, a fixing column being disposed in the clamping member other than the screw hole;
wherein the clamping member fastens the female-connecting end, a screw inserted in the screw hole is pressed on the periphery of the female-connecting end, the fixing column is inserted from the through hole disposed in the bottom of the female-connecting end and urged on a bottom slot of the end of the axis, the plane is closely contacted with the female-connecting end.

2. The fastening structure for the transmission rod of the drum hammer of claim 1, wherein the transmission rod is a square rod.

3. The fastening structure for the transmission rod of the drum hammer of claim 1, wherein the transmission rod is a round rod.

4. A fastening structure for a transmission rod of a drum hammer, comprising:
a transmission rod, which is connected to a pedal for transmitting power;
two universal connectors, which are disposed two ends of the transmission rod respectively, each of the universal connectors having a female-connecting end, a female-connecting hole being disposed in the female-connecting end, an upper portion in the female-connecting hole having a plane, which corresponds to a through hole disposed in a lower portion of the female-connecting hole;
two axes, an end of each axis having a plane; and
two fixing structures, each fixing structure having a clamping member, which has an inner hole and a first screw hole from the top of the clamping member through to the inner hole, a second screw being accommodated in a second screw hole by way of screwing to form a fixing column, the second screw hole being disposed in the clamping member other than the first screw hole;
wherein the clamping member fastens the female-connecting end, a first screw inserted in the first screw hole is pressed on the periphery of the female-connecting end, the second screw is inserted from the through hole disposed in the bottom of the female-connecting end and urged on a bottom slot of the end of the axis, the plane is closely contacted with the female-connecting end.

5. The fastening structure for the transmission rod of the drum hammer of claim 4, wherein the transmission rod is a square rod.

6. The fastening structure for the transmission rod of the drum hammer of claim 4, wherein the transmission rod is a round rod.
